(19) United States
(12) Patent Application Publication
(10) Pub. No.: US 2017/0059762 A1
(43) Pub. Date: Mar. 2, 2017

(54) BACKLIGHT UNIT AND DISPLAY APPARATUS INCLUDING THE SAME

(71) Applicant: Samsung Display Co., Ltd., Yongin-Si (KR)

(72) Inventors: Young-min PARK, Hwaseong-si (KR); Eunju NAM, Seoul (KR); Min-young SONG, Asan-si (KR); Ho-sik SHIN, Gunpo-si (KR); Hayoung LEE, Seoul (KR)

(21) Appl. No.: 15/156,765

(22) Filed: May 17, 2016

(30) Foreign Application Priority Data
Sep. 2, 2015 (KR) 10-2015-0124306

(51) Int. Cl. F21V 8/00; G02F 1/29

(52) U.S. Cl. CPC G02B 6/005; G02F 1/29

(57) ABSTRACT

A backlight unit includes: a light guide member including an light incident surface which receives light, a light emitting surface bent from the light incident surface, and a rear surface bent from the light incident surface and parallel to the light emitting surface; a light source which provides light to the light incident surface; and a refractive index control member disposed on the rear surface and divided into a plurality of areas on a plane parallel to the light emitting surface, where an electric field is generated for each area. Each of the areas is in a first state to have a first refractive index or in a second state to have a second refractive index, which is different from the first state, based on the electric field generated therein.

This application claims priority to Korean Patent Application No. 10-2015-0124306, filed on Sep. 2, 2015, and all the benefits accruing therefrom under 35 U.S.C. §119, the content of which in its entirety is herein incorporated by reference.

### BACKGROUND

1. Field

The disclosure relates to a backlight unit and a display apparatus including the backlight unit, and more particularly, to a backlight unit for performing local dimming control and a display apparatus including the backlight unit.

2. Description of the Related Art

A liquid crystal display apparatus, which is one of the most widely used types of flat panel display apparatus, includes a backlight unit for providing light.

The backlight unit is typically classified into an edge type backlight unit and a direct type backlight unit according to a position of a light source block. The light source block of the edge type backlight unit is disposed on a side surface of the display panel, whereas the light source block of the direct type backlight unit is disposed on a rear surface of the display panel.

Recently, the local dimming technique that changes brightness of a predetermined area among a plurality of areas is being developed to reduce power consumption of the liquid crystal display apparatus.

### SUMMARY

The disclosure provides an edge type backlight unit capable of performing local dimming control and a display apparatus including the backlight unit.

According to an embodiment of the inventive concept, a backlight unit includes: a light guide member including a light incident surface which receives light, a light emitting surface bent from the light incident surface, and a rear surface bent from the light incident surface and parallel to the light emitting surface; a light source which provides light to the light incident surface; and a refractive index control member disposed on the rear surface and divided into a plurality of areas on a plane parallel to the light emitting surface, where an electric field is generated for each of the areas. In such an embodiment, each of the areas is in a first state to have a first refractive index or in a second state to have a second refractive index, which is different from the first state, based on the electric field generated therein.

In an embodiment, the first refractive index may be substantially the same as a refractive index of the light guide member.

In an embodiment, the second refractive index may be less than the first refractive index.

In an embodiment, the refractive index control member may include: a refractive index control layer including refractive index anisotropic materials; a first electrode layer disposed below the refractive index control layer; and a second electrode layer disposed on the refractive index control layer, and the refractive index control member may control a refractive index of the refractive index control layer based on the electric fields generated by the first and second electrode layers.

In an embodiment, the refractive index anisotropic materials in an area of the refractive index control member may be arranged in a first direction when the area is in the first state and the refractive index anisotropic materials of the area of the refractive index control member may be arranged in a second direction, which is different from the first direction, when the area is in the second state.

In an embodiment, the second electrode layer may contact the light guide member, and the second electrode layer may have the first refractive index.

In an embodiment, the refractive index control layer may include a liquid crystal.

In an embodiment, at least one of the first and second electrode layers may include a plurality of electrodes disposed in the areas, respectively, and the electrodes may be controlled independently of each other.

In an embodiment, the first electrode layer may include the electrodes, a first electrode corresponding to the first area and a second electrode corresponding to the second area, among the electrodes, may receive voltages different from each other.

In an embodiment, the refractive index control member may further include a reflective layer disposed below the first electrode layer.

In an embodiment, the reflective layer may diffusely reflect light incident thereto.

In an embodiment, the light source may include a plurality of light emitting diodes arranged along the light incident surface.

In an embodiment, the light source may be provided in plural, a plurality of light sources may be spaced apart from each other, and the light guide member is disposed between the light sources.

According to an embodiment of the inventive concept, a display apparatus includes: a display member; a light guide member including a light incident surface which receives light, a light emitting surface bent from the light incident surface to face the display member, and a light guide member bent from the light incident surface and parallel to the light emitting surface; a light source which provides the light to the light incident surface; and a refractive index control member disposed on the rear surface and divided into a plurality of areas on a plane parallel to the light emitting surface, where an electric field is generated for each of the areas, In such an embodiment, each of the area is in a first state to have a first refractive index or in a second state to have a second refractive index, which is different from the first refractive index, based on the electric field generated therein.

In an embodiment, the display member may include a plurality of pixels, where each of the areas corresponds to at least two pixels of the pixels, and the refractive index control member may generate the electric field in each of the areas based on luminance of an image displayed by the pixels corresponding to each of the areas.

In an embodiment, the refractive index control member may include: a refractive index control layer including refractive index anisotropic materials; a first electrode layer disposed below the refractive index control layer; and a second electrode layer disposed above the refractive index control layer, where a direction of the refractive index anisotropic materials may be controlled based on the electric field between the first and second electrode layers, and directions of the refractive index anisotropic materials in the first and second states may be different from each other.

In an embodiment, the first electrode layer may include a plurality of electrodes corresponding to the areas, respectively, and a first electrode corresponding to the first area and a second electrode corresponding to the second area, among the electrodes, may receive voltages different from each other.

In an embodiment, the second electrode layer may contact the light guide member, and the second electrode layer may have the first refractive index.

In an embodiment, the refractive index control layer may include a liquid crystal.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is an exploded perspective view of a display apparatus according to an embodiment of the inventive concept;

FIG. 2 is a block diagram of the display apparatus according to an embodiment of the inventive concept;

FIG. 3 is a schematic projected perspective view of a display member according to an embodiment of the inventive concept;

FIG. 4 is an exploded perspective view of a backlight unit according to an embodiment of the inventive concept;

FIGS. 5A and 5B are cross-sectional views taken along line I-I′ of FIG. 4;

FIG. 6 is a plan view of a refractive index control member;

FIG. 7 is a perspective view of the backlight unit according to an embodiment of the inventive concept;

FIGS. 8A to 8C are plan views of the backlight unit illustrated in FIG. 7;

FIGS. 9A and 9B are cross-sectional views of the backlight unit according to an embodiment of the inventive concept; and

FIGS. 10A to 10C are cross-sectional views of the refractive index control member according to an embodiment of the inventive concept.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of a display apparatus according to the inventive concept will be described in detail with reference to the accompanying drawings.

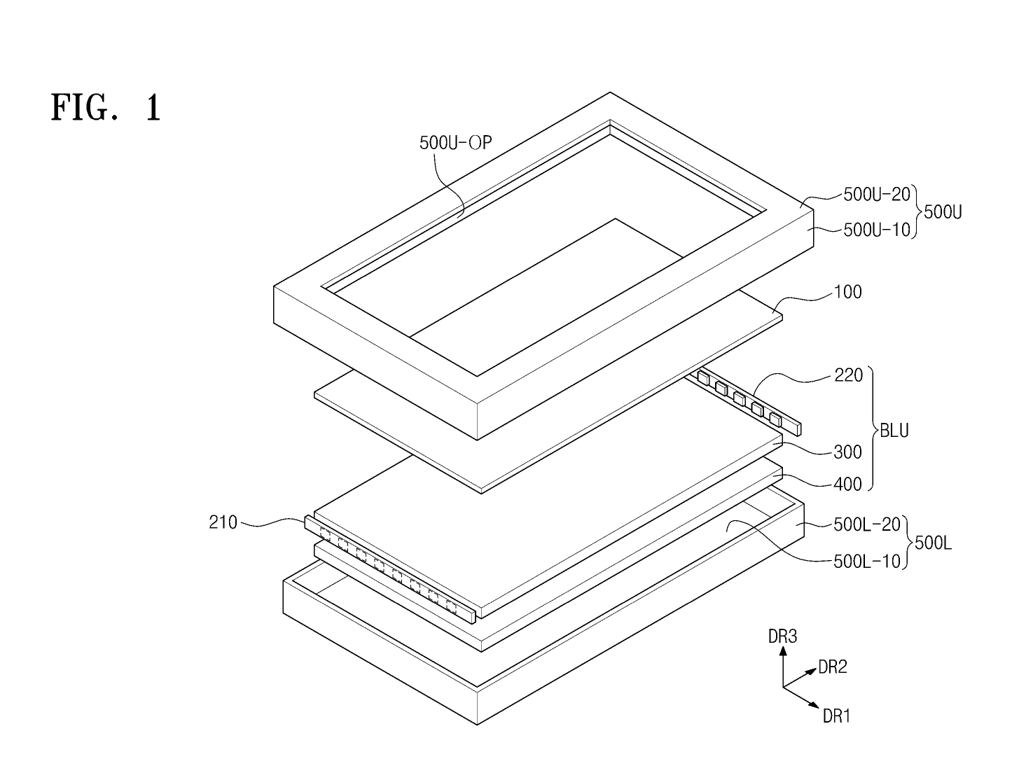

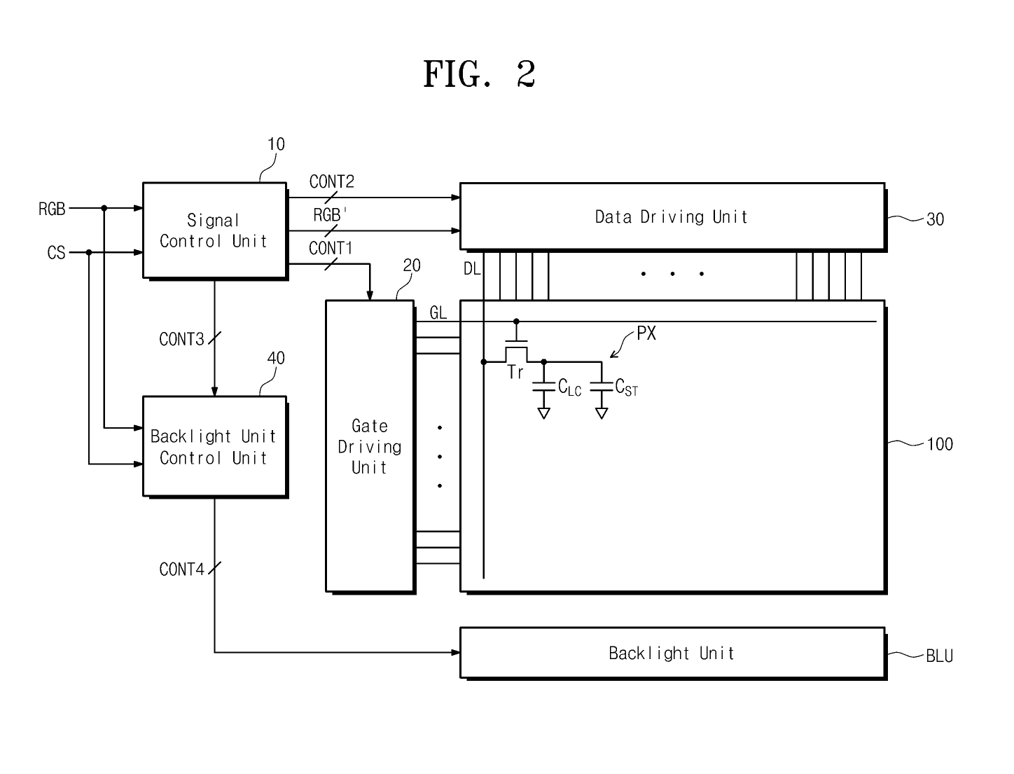

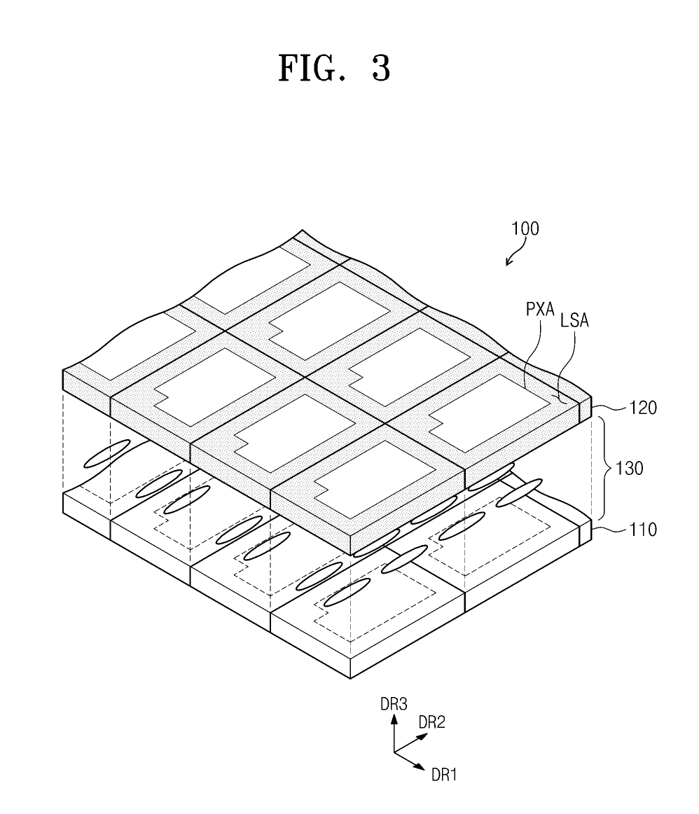

FIG. 1 is an exploded perspective view of the display apparatus according to an embodiment of the inventive concept. FIG. 2 is a block diagram of the display apparatus according to an embodiment of the inventive concept. FIG. 3 is a schematic projected perspective view of a display member according to an embodiment of the invention;

An embodiment of the display apparatus includes a display member (or a display panel) 100, a backlight unit (or a backlight module) BLU, a lower accommodation member (e.g., a lower chassis) 500L, and an upper accommodation member (e.g., an upper chassis) 500U. The display apparatus may include a driving circuit for driving the display member 100 and the backlight unit BLU. The driving circuit may include a signal control unit (or a signal controller) 10, a gate driving unit (or a gate driver) 20, a data driving unit (or a data driver) 30, and a backlight unit control unit (or a backlight unit controller) 40.

The display member 100 receives an electric signal from the outside to display an image. The display member 100 may include various embodiments. In one embodiment, for example, the display member 100 may include a liquid crystal display panel, an electrophoretic display panel, or an electrowetting display panel.

Hereinafter, an embodiment where the display member 100 includes the liquid crystal display panel will be described in detail for convenience of description. In such an embodiment, the liquid display panel may be one of a vertical alignment (“VA”) mode panel, a patterned vertical alignment (“PVA”) mode panel, an in-plane switching (“IPS”) mode panel or a fringe-field switching (“FFS”) mode panel, and a plane to line switching (“PLS”) mode panel, but not being limited to a specific mode panel.

Referring to FIG. 3, the display member 100 may include a first substrate 110, a second substrate 120, and a liquid crystal layer 130 disposed between the first and second substrates 110 and 120. Signal lines DL and GL and a thin film transistor Tr are disposed in at least one of the first substrate 110 and the second substrate 120.

The liquid crystal layer 130 is a component that defines a liquid crystal capacitor CLC. An amount of light passing through the liquid crystal layer 130 may be determined by the liquid crystal capacitor CLC. A storage capacitor CST assists the liquid crystal capacitor CLC.

In an embodiment, as illustrated in FIG. 3, the display member 100 may be divided into a plurality of pixel areas PXA and a plurality of peripheral areas LSA. Pixels PX are disposed in the pixel areas PXA, respectively. The pixel areas PXA may allow light to pass therethrough or to be blocked according to a state of the liquid crystal layer 130.

The peripheral areas LSA are disposed adjacent to the pixel areas PXA, respectively. The peripheral areas LSA block the light. In such an embodiment, various signal lines disposed in the peripheral areas LSA may be effectively prevented from being seen from the outside, and light leakage in the peripheral areas LSA may be effectively prevented.

The display member 100 controls a transmittance of the liquid crystal layer 130 to display an image. The display member 100 may be divided into the plurality of pixel areas PXA and the peripheral areas LSA disposed adjacent to the pixel areas PXA, respectively, in a plane defined by a first direction DR1 and a second direction DR2 or when viewed from a plane view in a direction perpendicular to the first direction DR1 and the second direction DR2. Pixels may be disposed in the pixel areas PXA, respectively.

The display member 100 includes a plurality of signal lines and a plurality of pixels connected to the signal lines, respectively. The signal lines are disposed in at least one of the first substrate 110 and the second substrate 120. FIG. 2 exemplarily illustrates a pixel PX connected to a gate line GL and a data line DL.

The signal lines include a plurality of gate lines and a plurality of data lines. The gate lines and the data lines may be insulated from each other to cross each other. Each pixel PX is connected to a corresponding gate line GL of the gate lines and a corresponding data line DL of the data lines.

In an embodiment, as shown in FIG. 2, the display apparatus may include a driving circuit for driving the display member 100 and the backlight unit BLU. The driving circuit may include the signal control unit 10, the gate driving unit 20, the data driving unit 30, and the backlight unit control unit 40.

In an embodiment, the signal control unit 10 receives input image signals RGB inputted from the outside to convert the input image signals RGB into an image data RGB′ corresponding to an operation of the display member 100. In such an embodiment, the signal control unit 10 receives various kinds of control signals CS, such as a vertical synchronizing signal, a horizontal synchronizing signal, a main clock signal and an enable signal, for example, to output first to third control signals CONT1, CONT2 and CONT3.

The gate driving unit 20 outputs gate voltages to the gate lines in response to the first control signal CONT1. In an embodiment, the gate voltages may be sequentially applied to the gate lines.

The first control signal CONT1 includes a vertical start signal for beginning an operation of the gate driving unit 20, a gate clock signal for determining a time for outputting the gate voltages, and an output enable signal for determining an on-pulse width of the gate voltage.

The data driving unit 30 receives the second control signal CONT2 and the image data RGB′. The data driving unit 30 converts the image data RGB′ into the data voltages to provide the converted data voltages to the data lines.

The second control signal CONT2 includes a horizontal start signal for beginning an operation of the data driving unit 30, an inversion signal for inverting polarities of the data signals, and an output commanding signal for determining a time for outputting the data voltages.

The third control signal CONT3 drives the backlight unit driving unit 40. The backlight unit driving unit 40 receives the input image signals RGB, the control signal CS, and the third control signal CONT3 to output the fourth control signal CONT4.

The backlight unit driving unit 40 may be synchronized with the signal control unit 10. The backlight unit driving unit 40 may be disposed or mounted on an external system board or embedded in the signal control unit 10.

The backlight unit BLU may receive the fourth control signal CONT4 to control luminance of light which is outputted from each of predetermined areas. The fourth control signal CONT4 is generated based on the input image signals RGB and the control signal CS. Accordingly, the backlight unit BLU may control luminance of light provided to the display member 100 according to an image displayed on the display member 100. This will be described later in detail.

In an embodiment, as shown in FIG. 2, the pixel PX includes a thin film transistor Tr, a liquid crystal capacitor CLC, and a storage capacitor CST. However, this is exemplarily illustrated. In one alternative embodiment, for example, the display member 100 may not include the storage capacitor CST.

In such an embodiment, the thin film transistor Tr includes a control electrode connected to the gate line GL, an input electrode connected to the data line, and an output electrode connected to the liquid crystal capacitor CLC. The thin film transistor Tr is turned on or off based on a voltage provided from the gate line GL, and the thin film transistor Tr transmits a voltage provided from the data line DL to the liquid crystal capacitor CLC when the thin film transistor Tr is turned on.

When the gate voltage is applied to the gate line GL, the data voltage is applied to the data line DL in synchronization with the gate voltage. Accordingly, the thin film transistor Tr connected to the gate line GL is turned on in response to the corresponding gate voltage.

When the data signal is applied to the data line DL connected to the turned-on thin film transistor, the applied data signal is transmitted through the thin film transistor Tr and is charged to the liquid crystal capacitor CLC and the storage capacitor CST.

The liquid crystal capacitor CLC adjusts a light transmittance of liquid crystal according to the charged voltage. The storage capacitor CST charges the data voltage when the thin film transistor Tr is turned on and applies the charged data voltage when the thin film transistor Tr is turned off to maintain the charging of the liquid crystal capacitor CLC. Accordingly, the display member 100 may display the image.

Referring back to FIG. 1, the backlight unit BLU may include a light source, a light guide member 300, and a refractive index control member (e.g., a refractive index control layer) 400. According to the embodiment, the light source may include a first light source 210 and a second light source 220, which are spaced apart from each other in the second direction DR2. Accordingly, the light that is guided through the light guide member 300 may be efficiently blended or extracted.

Each of the first and second light sources 210 and 220 generates light. Each of the first and second light sources 210 and 220 may include a light emitting device and a circuit board connected to the light emitting device. The light emitting device is electrically connected to the circuit board to receive an electrical signal from the circuit board and generate light.

In an embodiment, each of the first and second light sources 210 and 220 include at least one of various light emitting devices. In one embodiment, for example, each of the first and second light sources 210 and 220 may include a light emitting diode (“LED”), a cold cathode fluorescent lamp (“CCFL”), or an external electrode fluorescent lamp (“EEFL”). In an embodiment, the first and second light sources 210 and 220 include the light emitting devices that are different from each other, but an embodiment of the inventive concept is not limited thereto.

In an embodiment, each of the first and second light sources 210 and 220 may include a plurality of light emitting diodes. Each of the first and second light sources 210 and 220 may generate single color light or blended color light, and the light emitting devices may also generate color lights different from each other.

In an embodiment, each of the first and second light sources 210 and 220 controls the light emitting devices through a single circuit board, but an embodiment of the inventive concept is not limited thereto. In one alternative embodiment, for example, each of the first and second light sources 210 and 220 may provide an electrical signal to the light emitting device through different circuit boards to control the light emitting devices independently of each other.

Each of the first and second light sources 210 and 220 is disposed on a side surface of the light guide member 300. In an embodiment, as shown in FIG. 1, a first light source 210 provides light to a side surface of the light guide member 300, and a second light source 220 provides the light to an opposing side surface of the light guide member 300, but an embodiment of the inventive concept is not limited thereto.

In an alternative embodiment, one of the first and second light sources 210 and 220 may be omitted, or a light source for providing light to another side surface of the light guide member 300 may be further provided, but an embodiment of the inventive concept is not limited thereto.

The light guide member 300 guides incident light to change a path of the light incident thereto. The light guide member 300 may have a plate-like shape with a plurality of surfaces.

The light guide member 300 may include a first surface facing the display member 100, a second surface facing the refractive index control member 400, and a plurality of connecting surfaces that connect the first surface to the second surface. Here, the first surface is defined as a light emitting surface, and the second surface is defined as a rear surface. Also, a surface facing the light source of the connecting surfaces may be defined as a light incident surface. Accordingly, two light incident surfaces facing each other in the second direction DR2 may be defined on the light guide member 300.

The light guide member 300 receives light from the first and second light sources 210 and 220 through the light incident surfaces. The received light may be provided to the display member 100 through the light emitting surface. The display member 100 provides an image to a user by using the light provided from the backlight unit BLU.

The refractive index control member 400 is disposed on a rear surface of the light guide member 300. The refractive index control member 400 may control a refractive index for each area on the plane defined by the first direction DR1 and the second direction DR2.

In one embodiment, for example, the refractive index control member 400 may be divided into areas having different refractive indexes from each other on the plane or when viewed from a plan view in a thickness direction of the refractive index control member 400 or a direction perpendicular to the first direction DR1 and the second direction DR2. A light guide path of the light guide member 300 may be changed according to the refractive index of the refractive index control member 400. Accordingly, an amount of light of the backlight unit BLU outputted for each area may be different from each other. This will be described later in detail.

In an embodiment, as shown in FIG. 1, the lower accommodation member 500L includes a bottom part 500L-10 and a sidewall part 500L-20. The sidewall part 500L-20 is bent from the bottom part 500L-10 toward an upper side DR3 or a vertical direction (hereinafter, referred to as a third direction DR3). The bottom part 500L-10 and the sidewall part 500L-20 define a predetermined inner space. The display member 100, the backlight unit BLU and the driving circuit (not shown) may be accommodated in the inner space.

The upper accommodation member 500U includes a sidewall part 500U-10 and an upper unit 500U-20. A predetermined opening 500U-OP is defined in the upper unit 500U-20. The upper unit 500U-20 partially covers the display member 100.

The user recognizes the image displayed on the display member 100 through the opening 500U-OP. The sidewall part 500U-10 is bent downward from the upper unit 500U-20. The sidewall part 500U-10 defines a side surface of the display apparatus. The sidewall part 500U-10 may surround the lower accommodation member 500L. The lower accommodation member 500L and the upper accommodation member 500U are coupled to each other, thereby defining an overall shape of the display apparatus.

However, such accommodation members are merely exemplary. In one alternative embodiment, for example, the display apparatus may include various types of accommodation members. Although the accommodation members have various shapes to accommodate the display member 100 and the backlight unit BLU, an embodiment of the inventive concept is not limited thereto.

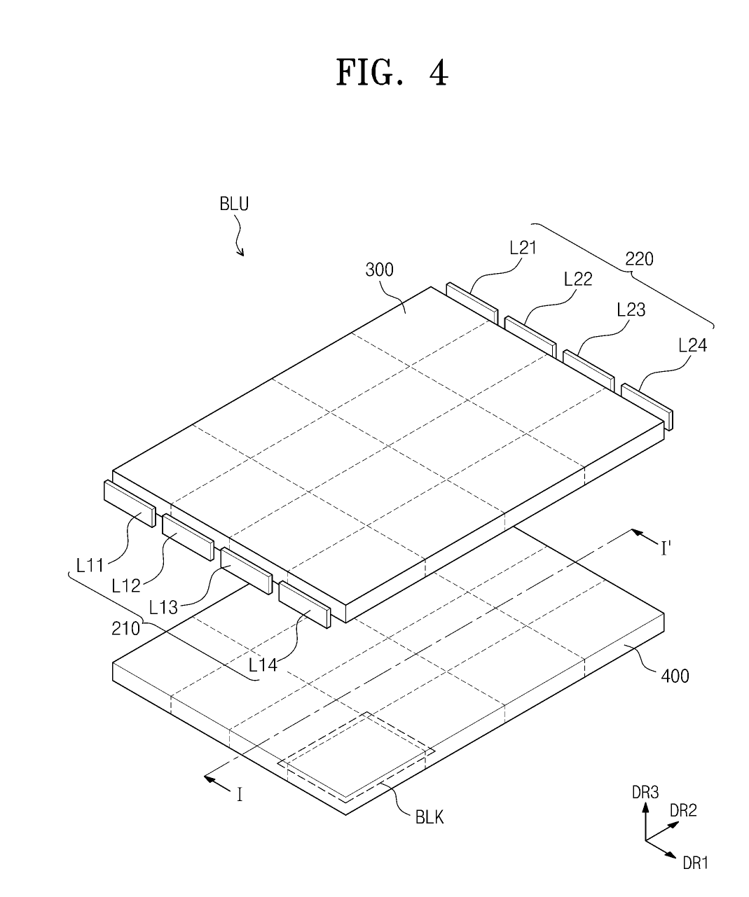

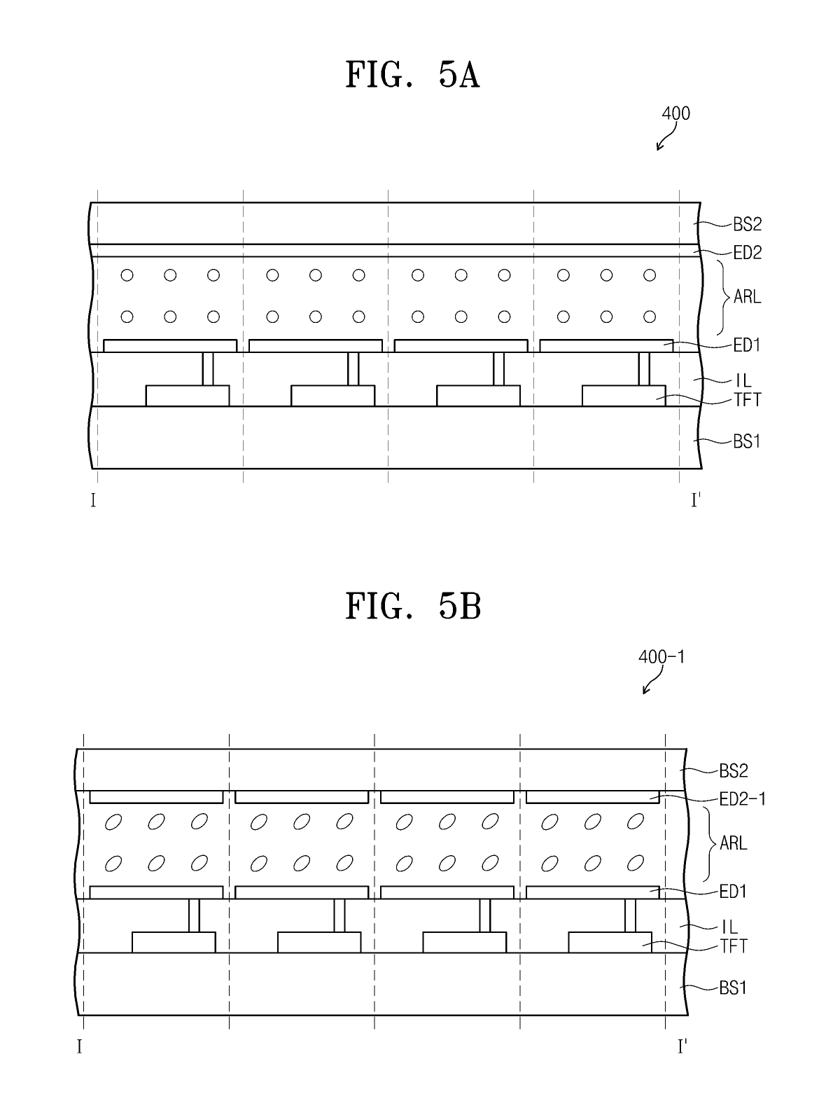

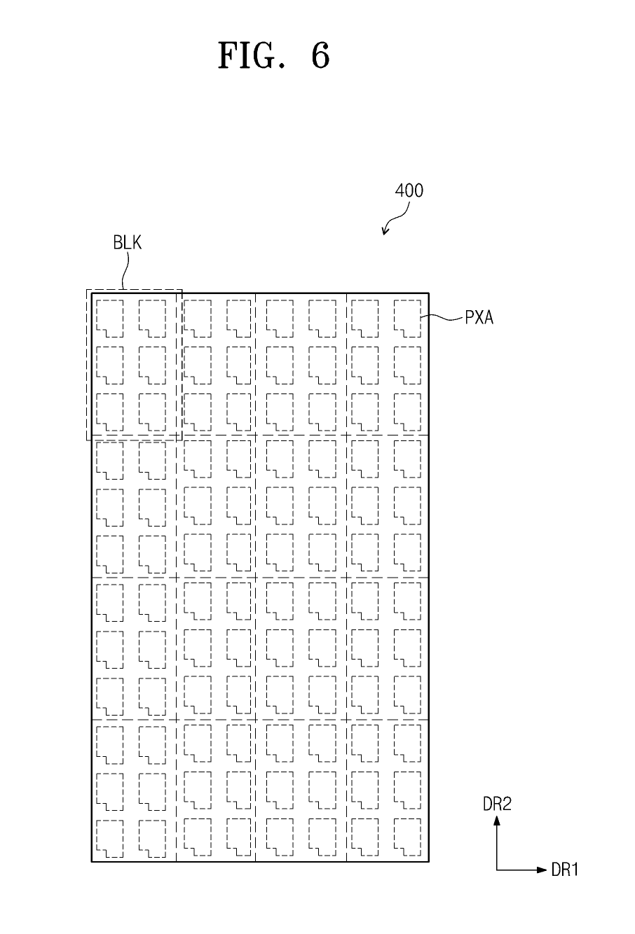

FIG. 4 is an exploded perspective view of the backlight unit according to an embodiment of the inventive concept. FIGS. 5A and 5B are cross-sectional views taken along line I-I′ of FIG. 4. FIG. 6 is a plan view of the refractive index control member 400.

FIGS. 5A and 5B illustrate the refractive index control members in states different from each other. FIG. 6 illustrates a relationship between the refractive index control member 400 and the display member (see reference numeral 100 in FIG. 1).

For convenience of description, FIGS. 4 to 5B exemplarily illustrate four light emitting devices L11, L12, L13, and L14 constituting the first light source 210 and four light emitting devices constituting the second light source 220. Hereinafter, the backlight unit according to an embodiment of the inventive concept will be described with reference to FIGS. 4 to 6. The same reference numeral may be given to the same constituent as those of FIGS. 1 to 3, and any repetitive detailed description thereof will be omitted.

The refractive index control member 400 may be divided into a plurality of light emitting areas on the plane. The light emitting areas may be arranged in a matrix form on the plane. The refractive index control member 400 may control the refractive index for each light emitting area. Accordingly, the backlight unit BLU may control an amount of light outputted for each light emitting area.

In an embodiment, a light emitting area BLK of the light emitting areas may overlap the plurality of pixel areas PXA. In such an embodiment, the light emitting area BLK may correspond to the plurality of pixel areas PXA to provide the amount of light corresponding to the image displayed by the plurality of pixel areas PXA. Although, for convenience of description in the specification, imaginary division lines are illustrated in the figures to show the light emitting areas on the light guide member 300, but an embodiment of the inventive concept is not limited thereto.

In an embodiment, the light emitting area BLK may have various surface areas. In such an embodiment, as the plurality of pixel areas PXA allocated to the light emitting area BLK increases, that is, as the area of the light emitting area BLK increases, the local dimming control may be performed with low power consumption.

As the plurality of pixel areas PXA allocated to the light emitting area BLK decreases, that is, as the area of the light emitting area BLK decreases, the fine local dimming control may be performed, and the display apparatus having high resolution may be realized.

A width of the light emitting area BLK in the first direction DR1 may be determined by the light emitting devices. Since each of the first and second light sources 210 and 220 includes four light emitting devices, the four light emitting areas are defined on the refractive index control member 400 in the first direction DR1.

Referring to FIGS. 5A and 5B, the refractive index control member 400 may include a first base substrate BS1, a first electrode layer ED′, a refractive index control layer ARL, a second electrode layer ED2, and a second base substrate BS2.

The first electrode layer ED1 is disposed on a surface (e.g., an upper or inner surface) the first base substrate BS1, and the second electrode layer ED2 is disposed on a surface (e.g., a lower or inner surface) of the second base substrate BS2. The second electrode layer ED2 is spaced apart from the first electrode layer ED1, and the refractive index control layer ARL is disposed therebetween.

The refractive index control layer ARL has a refractive index that is controlled according to an electric field formed between the first and second electrode layers ED1 and ED2. The refractive index control layer ARL may be switched between a first state having a first refractive index and a second state having a second refractive index according to the electric field.

The refractive index control layer ARL includes a refractive index anisotropic material. The refractive index anisotropic material may vary. In one embodiment, for example, the refractive index anisotropic material may be liquid crystal.

The refractive index control layer ARL may be in a state switched between the first state and the second state according to alignments or directivities of the refractive index anisotropic materials. In one embodiment, for example, when a first electric field is formed between the first and second electrode layers ED1 and ED2, the refractive index anisotropic materials may have the first state in which the refractive index anisotropic materials are arranged in the first direction. In such an embodiment, when a second electric field is formed between the first and second electrode layers ED1 and ED2, the refractive index anisotropic materials may have the second state in which the refractive index anisotropic materials are arranged in a second direction that is different from the first direction.

According to an embodiment, the refractive index control layer ARL may be easily switched between the states having the refractive indexes different from each other based on voltage difference between the first and second electrode layers ED1 and ED2. The refractive index control member 400 may control the refractive index of the refractive index control layer ARL for the areas to control light output luminance of the backlight unit BLU for the areas. This will be described later in detail.

In an embodiment, as illustrated in FIG. 5A, the first electrode layer ED1 may include a plurality of electrodes. The electrodes are arranged with a pattern corresponding to the light emitting areas. Accordingly, the electrodes are disposed to correspond to the light emitting areas, respectively. Although the electrodes are respectively connected to signal lines (not shown) to receive an independent signal from the driving circuit (refer to FIG. 2), an embodiment of the inventive concept is not limited thereto. In such an embodiment, the second electrode layer ED2 may have a plate-like shape to cover all of the light emitting areas.

In an alternative embodiment, as illustrated in FIG. 5B, a refractive index control member 400-1 may include a second electrode layer ED2-1 including a plurality of electrodes, which may be disconnected from each other. Accordingly, all electrode layers for controlling the refractive index of the refractive index control layer ARL of the refractive index control member 400-1 may include a plurality of electrodes. Thus, the electric field for adjacent areas may be variously changed, e.g., independently controlled, to finely control the amount of light.

The refractive index control member 400 may further include a thin film transistor TFT. An insulation layer IL may be further disposed between the thin film transistor TFT and the electrode layer ED1. Although not shown, a plurality of signal lines connected to the thin film transistor TFT to drive the thin film transistor TFT may be further disposed on the first base substrate BS1.

In an embodiment, as shown in FIGS. 5A and 5B, the refractive index control member 400 may include a plurality of thin film transistors TFT coupled to the electrodes, respectively. Accordingly, each of the electrodes may be independently driven and independently receive voltages.

According to an embodiment of the inventive concept, the backlight unit BLU may control the refractive index for the light emitting areas that are arranged in the matrix form on the plane to control the amount of light according to a two-dimensional area. Thus, according to an embodiment of the inventive concept, although the backlight unit BLU does not include the direct type light source, the luminance of the areas in the second dimension from the edge type light source may be effectively controlled.

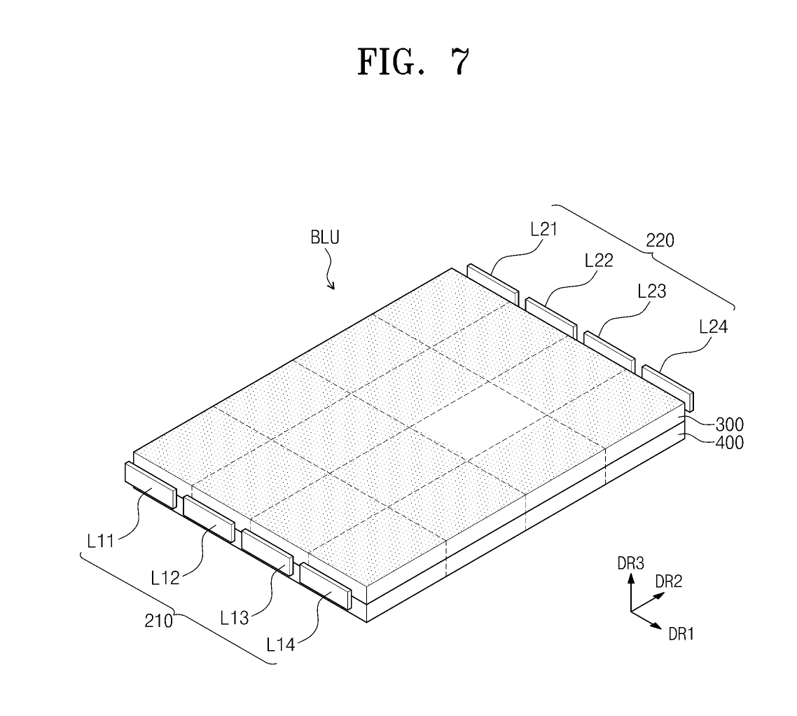

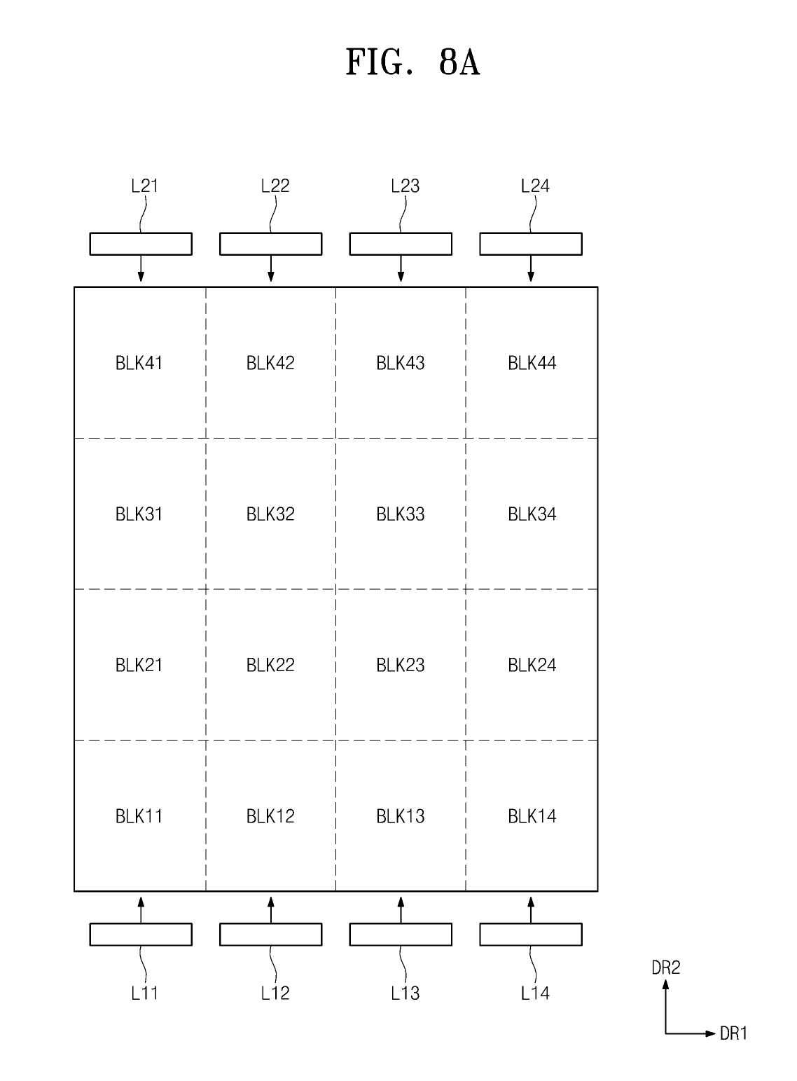

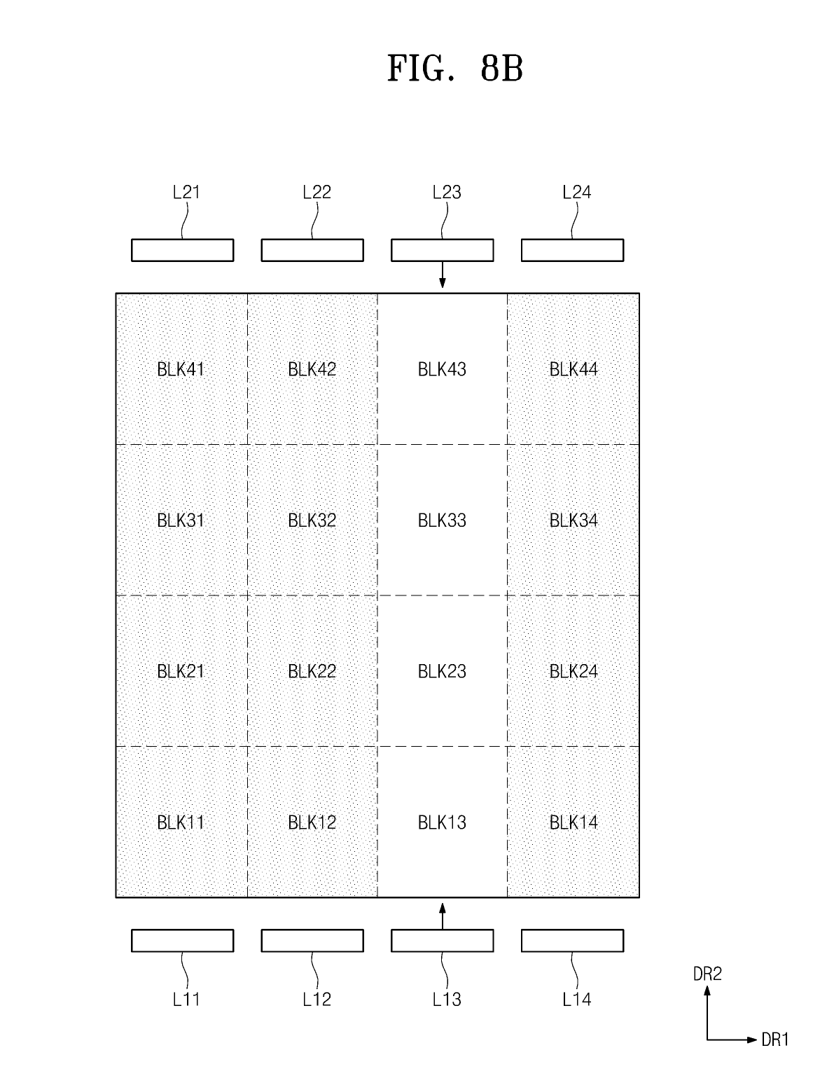

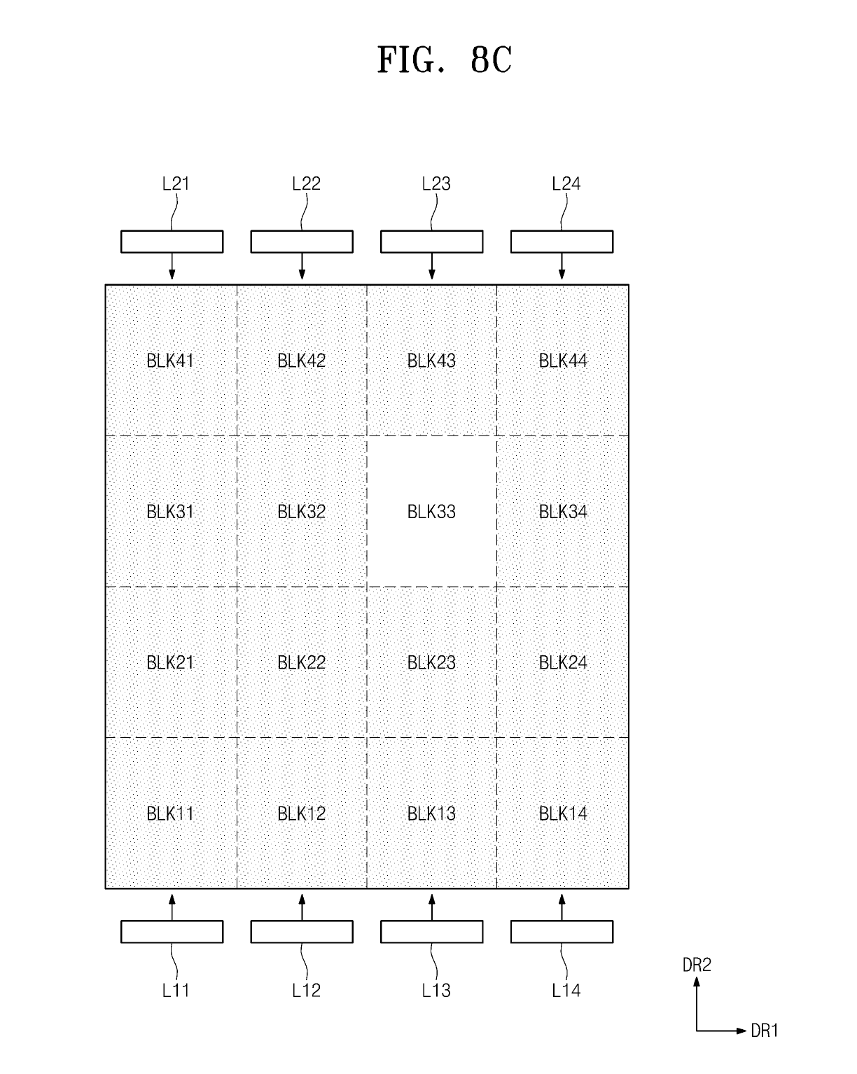

FIG. 7 is a perspective view of the backlight unit according to an embodiment of the inventive concept. FIGS. 8A to 8C are plan views of the backlight unit in FIG. 7. FIGS. 8A to 8C respectively illustrate embodiments in which the backlight units are differently driven.

As illustrated in FIGS. 7 to 8C, light emitting areas BLK11 to BLK44 in a 4×4 arrangement or matrix form on the plane are exemplarily defined on the backlight unit BLU. The backlight unit BLU may output light through one light emitting area BLK33 of the light emitting areas BLK11 to BLK44 and may not output the light though the rest of the light emitting areas.

The backlight unit BLU may independently control the output light for the respective light emitting areas BLK11 to BLK44 that are arranged on the two-dimensional area through the light sources 210 and 220 and the refractive index control member 400. Accordingly, the backlight unit BLU may provide the light outputted in various shapes on the two-dimensional area to the display member 100.

As illustrated in FIG. 8A, each of the four light emitting devices L11, L12, L13, and L14 of the first light source 210 and four light emitting devices L21, L22, L23, and L24 of the second light source 220 provide light toward the light guide member 300. Thus, the backlight unit BLU may output a uniform amount of light through an entire surface thereof.

As illustrated in FIG. 8B, the backlight unit BLU may control the light amount outputted through the light sources. As only the light emitting devices L12 and L23 of the four light emitting devices L11, L12, L13, and L14 of the first light source 210 and four light emitting devices L21, L22, L23, and L24 of the second light source 220 are turned on, and the rest of the light emitting devices L11, L12, L14, L21, L22, and L24 are turned off, the light may be outputted only through the light emitting areas BLK13, BLK23, BLK33, and BLK43. The backlight unit BLU may control the light sources to perform linear dimming control.

As illustrated in FIG. 8C, the backlight unit BLU may control the light outputted only through one light emitting area BLK33. Here, although all the light emitting devices L11 to L14 and L21 to L24 are turned on, the amount of light emitted through the light emitting area is controlled by the refractive index control member 400.

As described above, the backlight unit BLU controls the output light to correspond to the image displayed on the display member 100. Accordingly, the light emitting area corresponding to a dark area of the image displayed on the display member 100 may be controlled to have a relatively low luminance, and the light emitting area corresponding to a bright area may be controlled to have relatively high luminance.

In an embodiment, where the backlight unit BLU may perform the local dimming control on the two-dimensional area, the light corresponding to various images displayed on the display member 100 may be provided to the display member 100. Accordingly, in such an embodiment, color reproducibility of the display apparatus may be improved.

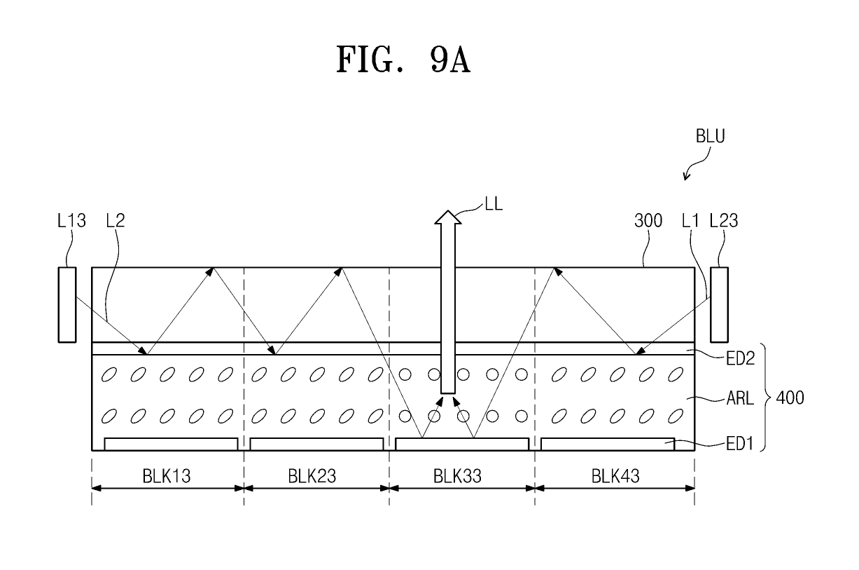

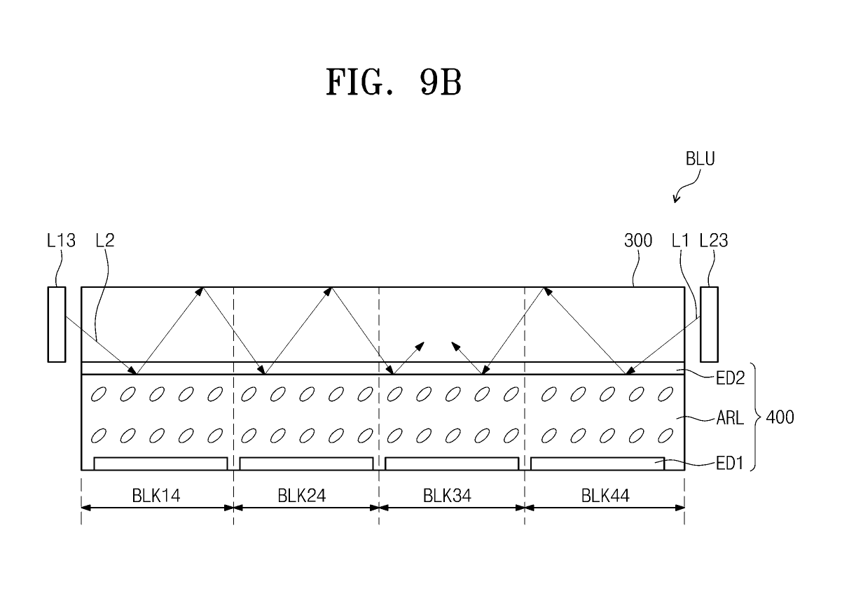

FIGS. 9A and 9B are cross-sectional views of the backlight unit according to an embodiment of the inventive concept. FIGS. 9A and 9B illustrate cross-sectional views indicating light paths in areas different from each other of the backlight unit BLU. Hereinafter, a dimming control method of the backlight unit BLU will now be described with reference to FIGS. 9A and 9B.

FIG. 9A illustrates a cross section of FIG. 8C. FIG. 9A illustrates the light emitting areas BLK13 to BLK43 including areas having different outputted light amounts.

The refractive index control member 400 may have different particle arrangement states for the respective light emitting areas BLK13 to BLK43. The refractive index control layer ARL may have the first refractive index in one light emitting area BLK33 among the light emitting areas BLK13 to BLK43 and the second refractive index in the remaining light emitting areas BLK13, BLK23, and BLK43 of the light emitting areas.

The second refractive index may be less than the first refractive index. In an embodiment, the second refractive index may be less than the refractive index of the light guide member 300. The first refractive index may be substantially the same as the refractive index of the light guide member 300.

In media different from each other, the light path in an interface may be changed according to a difference between the refractive indexes of the two media. As the difference between the two media increases and the refractive index of the interface decreases, light incident into the interface may be easily total-reflected.

In an embodiment, each of a first light L2 outputted from the light device L13 of the first light source and a second light L1 outputted from the light device L23 of the second light source is guided in the light guide member 300. Each of the first light L2 and the second light L1 that are incident into the light emitting areas BLK13, BLK23, and BLK43 having the low refractive index experiences the interface and is total-reflected into the light guide member 300. Accordingly, the first light L2 and the second light L1 are guided into the light guide member 300 and are not outputted to the outside.

When the first light L2 and the second light L1 are incident into the light emitting area BLK33 having the same refractive index as that of the light guide member 300, the first light L1 and the second light L2 do not experience the interface and recognize the media as the same media as each other.

Thus, the first light L2 and the second light L1 are incident into the refractive index control member 400. The light that is incident into the refractive index control member 400 is reflected by the first electrode layer ED1 and upward outputted. In such an embodiment, a diffuse-reflection is occurred by the first electrode layer ED′, such that the light may not further be guided by the light guide member 300 and outputted to the outside of the light guide member 300 as an output light LL.

FIG. 9B illustrates the light emitting areas BLK14 to BLK44 that are adjacent to the area illustrated in FIG. 9A. The light emitting areas BLK14 to BLK44 in FIG. 9B receive the light from the light emitting devices L14 and L24 that are different from the light emitting devices L13 and L23 that control the light emitting areas BLK13 to BLK43 in FIG. 9A.

Referring to FIG. 9B, the refractive index control member 400 may have the same refractive index over an entire surface of the light emitting areas BLK14 to BLK44. Here, when the refractive index control member 400 has the refractive index less than that of the light guide member 300, the first light L2 and the second light L1 may not be incident into the refractive index control member 400 and may be captured in the light guide member 300. Thus, the backlight unit BLU may not output the light through the entire surface of the light emitting areas BLK14 to BLK44.

In an embodiment, the second electrode layer ED2 may have substantially the same refractive index as that of the light guide member 300. In one embodiment, for example, the second electrode layer ED2 may include transparent conductive oxide. As the second electrode layer ED2 has substantially the same refractive index as that of the light guide member 300, the first light L2 and the second light L1 may have paths controlled by the refractive index of the refractive index control layer ARL itself.

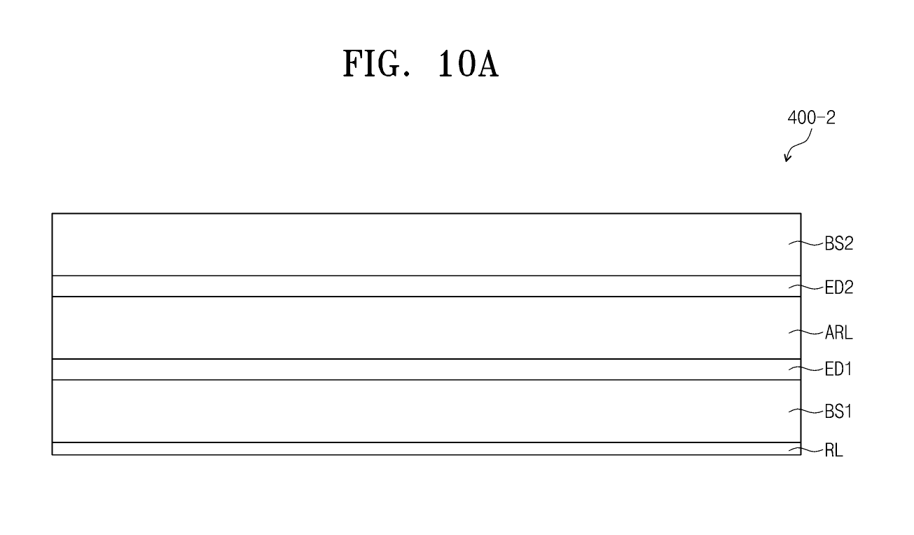

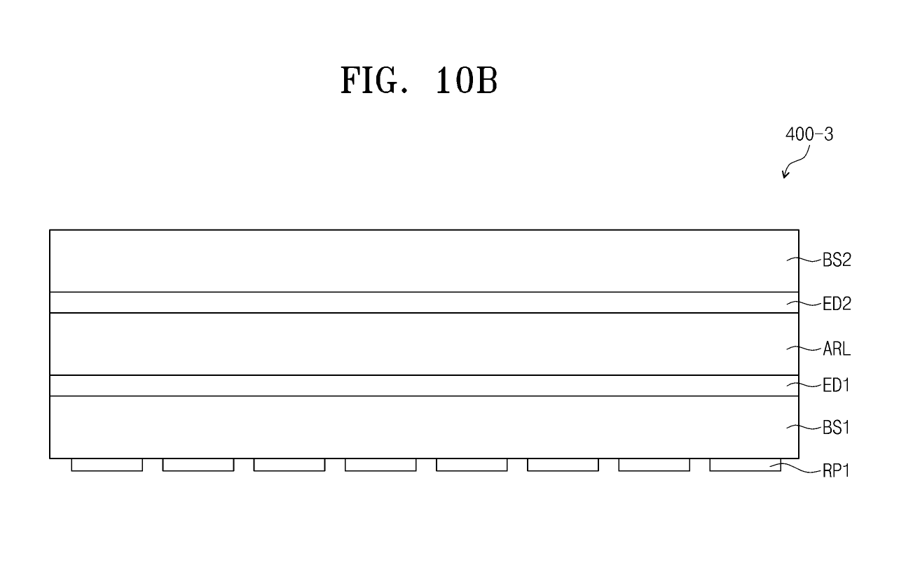

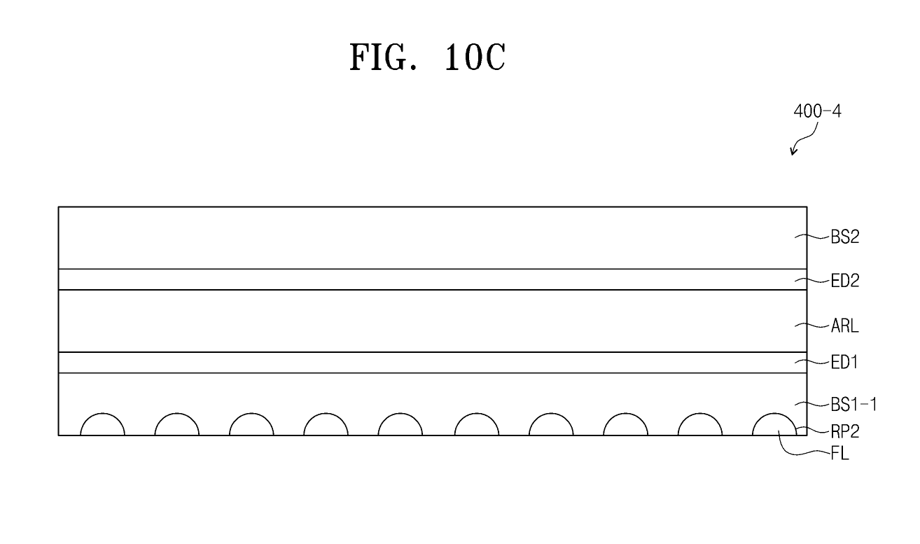

FIGS. 10A to 10C are cross-sectional views of the refractive control member according to an embodiment of the inventive concept. For convenience of description, only a lamination structure of the layers is illustrated. Hereinafter, various embodiments of the refractive index control member will be described with reference to FIGS. 10A to 10C.

In an embodiment, as illustrated in FIG. 10A, a refractive index control member 400-2 may further include a reflective layer RL. The reflective layer RL diffusely reflects incident light.

In such an embodiment, each of a first electrode layer ED1 and a first base substrate BS1 may have substantially the same refractive index as that of the refractive index control layer ARL. Thus, the light incident into the refractive index control layer ARL may not experience a boundary defined between two layer having different refractive indices from each other, and may pass through the first electrode layer ED1. The light passed through the first electrode layer ED1 may consecutively pass through the first base substrate BS1 and enter the refractive layer RL.

The light incident into the refractive layer RL is diffusely reflected by the refractive layer RL and re-reflected at various angles. Thus, the light may pass through the light guide member 300 to output to the outside.

In an alternative embodiment, as illustrated in FIG. 10B, a refractive index control member 400-3 may further include a convex pattern RP1. The convex pattern RP1 may be printed on a rear surface of the first base substrate BS1.

In such an embodiment, the convex pattern RP1 may function substantially the same as the reflective layer RL. The light incident into the convex pattern RP1 is distracted and reflected to output to the outside.

In another alternative embodiment, as illustrated in FIG. 10C, a refractive index control member 400-4 may include a first base substrate BS1-1 on which a concave pattern RP2 is defined. A space defined by the concave pattern RP2 may be filled with a predetermined material FL. The filled material FL and the concave pattern RP2 may distract and diffuse the incident light.

According to an embodiment of the inventive concept, the backlight unit may use the edge type light source and also perform the two-dimensional local dimming control. Thus, power consumption may be reduced and the display apparatus may decrease in thickness.

According to embodiments of the inventive concept, the backlight unit having the edge type light source arrangement may also perform the two-dimensional local dimming control. Accordingly, the edge type light source arrangement may be used instead of the direct type light source arrangement to reduce the power consumption. In such embodiments, since the local dimming control is enabled through the refractive index control using the voltage difference, the local dimming control method thereof may be simplified.

It will be apparent to those skilled in the art that various modifications and variations can be made in the embodiments of the inventive concept. Thus, it is intended that the embodiments of the inventive concept cover the modifications and variations of this invention provided they come within the scope of the appended claims and their equivalents.

What is claimed is:

1. A backlight unit comprising:
a light guide member comprising:
a light incident surface which receives light;
a light emitting surface bent from the light incident surface; and
a rear surface bent from the light incident surface and parallel to the light emitting surface;
a light source which provides light to the light incident surface; and
a refractive index control member disposed on the rear surface and divided into a plurality of areas on a plane parallel to the light emitting surface, wherein an electric field is generated for each of the areas,
wherein each of the areas is in a first state to have a first refractive index or in a second state to have a second refractive index, which is different from the first state, based on the electric field generated therein.

2. The backlight unit of claim 1, wherein the first refractive index is substantially the same as a refractive index of the light guide member.

3. The backlight unit of claim 2, wherein the second refractive index is less than the first refractive index.

4. The backlight unit of claim 2, wherein the refractive index control member comprises:
a refractive index control layer comprising refractive index anisotropic materials;
a first electrode layer disposed below the refractive index control layer; and
a second electrode layer disposed on the refractive index control layer,
wherein the refractive index control member controls a refractive index of the refractive index control layer based on the electric field generated by the first and second electrode layers.

5. The backlight unit of claim 4, wherein
the refractive index anisotropic materials in an area of the refractive index control member are arranged in a first direction when the area is in the first state, and
the refractive index anisotropic materials of the area of the refractive index control member are arranged in a second direction, which is different from the first direction, when the area is in the second state.

6. The backlight unit of claim 4, wherein
the second electrode layer contacts the light guide member, and
the second electrode layer has the first refractive index.

7. The backlight unit of claim 6, wherein the refractive index control layer comprises a liquid crystal.

8. The backlight unit of claim 6, wherein
at least one of the first and second electrode layers comprises a plurality of electrodes disposed in the areas, respectively, and
the electrodes are controlled independently of each other.

9. The backlight unit of claim 8, wherein
the areas comprise a first area and a second area,
wherein the electrodes of the first electrode layer comprise a first electrode corresponding to the first area and a second electrode corresponding to the second area, among the electrodes,
wherein the first and the second electrodes receive voltages different from each other.

10. The backlight unit of claim 6, wherein the refractive index control member further comprises a reflective layer disposed below the first electrode layer.

11. The backlight unit of claim 10, wherein the reflective layer diffusely reflects light incident thereto.

12. The backlight unit of claim 1, wherein the light source comprises a plurality of light emitting diodes arranged along the light incident surface.

13. The backlight unit of claim 12, wherein
the light source is provided in plural,
the plurality of light sources are spaced apart from each other,
the light guide member is disposed between the plurality of light sources.

14. A display apparatus comprising:
a display member;
a light guide member comprising:
a light incident surface which receives light;
a light emitting surface bent from the light incident surface to face the display member; and
a rear surface bent from the light incident surface and parallel to the light emitting surface;
a light source which provides the light to the light incident surface; and
a refractive index control member disposed on the rear surface and divided into a plurality of areas on a plane parallel to the light emitting surface, wherein an electric field is generated for each of the areas,
wherein each of the area is in a first state to have a first refractive index or in a second state to have a second refractive index, which is different from the first refractive index, based on the electric field generated therein.

15. The display apparatus of claim 14, wherein
the display member comprises a plurality of pixels, wherein each of the areas corresponds to at least two pixels of the pixels, and
the refractive index control member generates the electric field in each of the areas based on luminance of an image displayed by the pixels corresponding to each of the areas.

16. The display apparatus of claim 15, wherein the refractive index control member comprises:
a refractive index control layer comprising refractive index anisotropic materials;
a first electrode layer disposed below the refractive index control layer; and
a second electrode layer disposed above the refractive index control layer,
wherein a direction of the refractive index anisotropic materials is controlled based on the electric field between the first and second electrode layers, and
directions of the refractive index anisotropic materials in the first and second states are different from each other.

17. The display apparatus of claim 16, wherein
the first electrode layer comprises a plurality of electrodes corresponding to the areas, respectively,
the areas comprise a first area and a second area, and
a first electrode corresponding to the first area and a second electrode corresponding to the second area, among the electrodes, receive voltages different from each other.

18. The display apparatus of claim 16, wherein
the second electrode layer contacts the light guide member, and
the second electrode layer has the first refractive index.

19. The display apparatus of claim 16, wherein the refractive index control layer comprises a liquid crystal.
